(19) United States
(12) Patent Application Publication
(10) Pub. No.: US 2025/0361845 A1
(43) Pub. Date: Nov. 27, 2025

(54) AIR INTAKE DUCT FOR MOTOR VEHICLE

(71) Applicant: MAHLE International GmbH, Stuttgart (DE)

(72) Inventors: Tamon Fukushima, Saitama (JP); Yasunori Sato, Saitama (JP)

(21) Appl. No.: 19/218,585

(22) Filed: May 26, 2025

(30) Foreign Application Priority Data
May 27, 2024 (JP) 2024-085831

(51) Int. Cl. F02M 35/12; F02M 35/10

(52) U.S. Cl. CPC F02M 35/1266; F02M 35/10091

(57) ABSTRACT

An air intake duct for a motor vehicle includes a resonator having an outer wall that defines an internal space. At least one drain hole is configured as a penetrating channel through a bottom surface of the outer wall. A thick portion is disposed at least around the periphery of the drain hole to increase the length of the penetrating channel.

### CROSS REFERENCE TO RELATED APPLICATION

This application claims priority to Japanese Patent Application No. 2024-085831, filed on May 27, 2024, the contents of which is hereby incorporated by reference in its entirety.

### TECHNICAL FIELD

The present disclosure relates to an air intake duct for a motor vehicle.

### BACKGROUND

An intake duct is required to provide outside air to an engine in order to operate an engine of a motor vehicle, or the like. When air flows through an intake duct, intake noise may occur due to inherent vibrations, and the like. This intake noise is unpleasant to the driver of the vehicle, and so a resonator has conventionally been provided on the intake duct to reduce the intake noise. Resonators are often provided with drain holes because the installation location and shape can enable water to accumulate inside (see, for example, patent documents 1 to 5). However, the air passing through this drain hole may generate airflow noise at a certain air flow speed in the intake duct. As the demand for low noise in motor vehicles increases year by year, there is a need to suppress this airflow noise.

Conventionally, there is a known method of suppressing airflow noise generated from a drain hole by adding tuning holes, protrusions, or a straightening plate shape, or a combination of these, to the resonator. However, these methods require significant modifications to the intake duct path and the internal shape of the resonator.

### RELATED ART DOCUMENTS

### Patent Documents

Patent Document 1: Japanese Unexamined Utility Model Application Publication H2-1460
Patent Document 2: Japanese Unexamined Patent Application 2000-240520
Patent Document 3: Japanese Unexamined Patent Application 2010-144560
Patent Document 4: Japanese Unexamined Patent Application 2014-118920
Patent Document 5: Japanese Unexamined Patent Application 2022-144027

### SUMMARY

### Problem to be Solved

An object of the present disclosure is to provide an intake duct that can easily suppress airflow noise generated by air flowing through a drain hole of a resonator.

### Solutions

In one embodiment of the present disclosure, the object is achieved by an air intake duct where the resonator has an outer wall surrounding an internal space, and at least one drain hole formed as a penetrating channel penetrating the outer wall is provided on the bottom surface of the outer wall, and the length of the penetrating channel is extended by providing a thick portion at least on the periphery of the drain hole.

Therefore, drain holes can be provided where necessary and airflow noise can be suppressed without being restricted by the flow path of the intake duct or the internal shape of the resonator. In addition, the effect of suppressing airflow noise can be achieved simply by providing a drain hole with an extended length of the penetrating channel, which eliminates the need for major modifications to the intake duct path or the internal shape of the resonator.

Preferably, the penetrating channel has a radius at the entrance.

Preferably, the length of the penetrating channel is twice the thickness of the outer wall.

### BRIEF DESCRIPTION OF THE DRAWINGS

FIG. 1 is a bottom view of an air intake duct for a motor vehicle;

FIGS. 2(a) and 2(b) are cross-sectional views of the resonator; and

FIG. 3 is a graph depicting the effect of suppressing airflow noise by the resonator.

### DETAILED DESCRIPTION

Next, each of the embodiments of the present disclosure will be described while referencing the drawings. It should be noted that in the following description, the drawings are schematic, and the dimensional relationships between elements, the ratios between elements, and the like may differ from reality. The drawings may also include parts with different dimensional relationships, ratios, and the like.

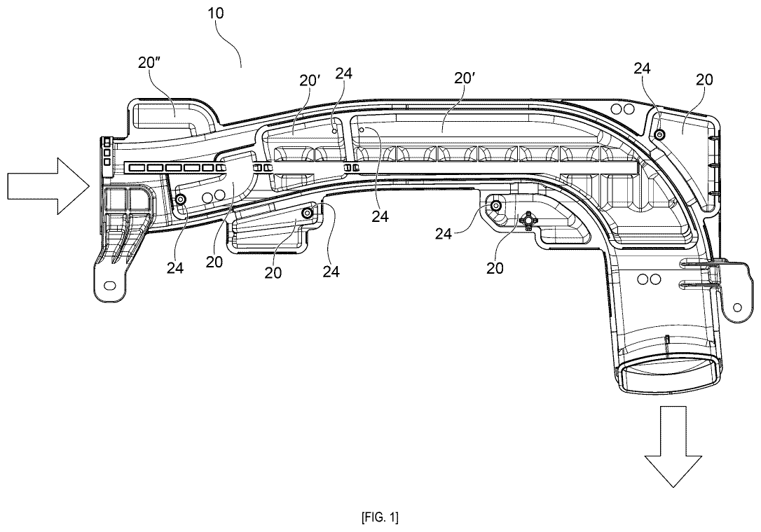

FIG. 1 is a bottom view of an air intake duct 10 for a motor vehicle. The arrow indicates the flow of outside air. Outside air introduced from outside the vehicle passes through an intake duct 10 and is supplied to an air cleaner (not depicted) to be filtered. The filtered outside air is directed downstream to the engine. A plurality of resonators 20, 20′, 20″ are provided on the bottom surface of the intake duct 10 to suppress intake noise of the intake duct. The resonators 20, 20′, 20″ have the effect of suppressing airflow noise that occurs due to natural vibration and the like when outside air flows through the intake duct 10. In FIG. 1, resonators 20 and 20′ are each provided with a drain hole 24, but resonator 20″ is not provided with a drain hole.

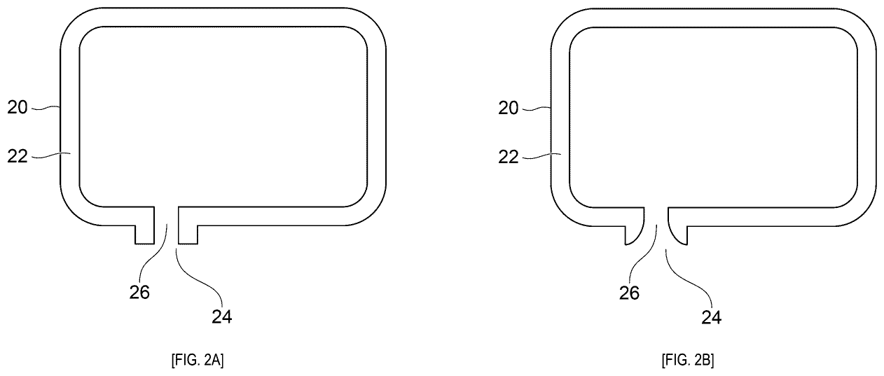

FIG. 2 is a schematic cross-sectional view of the resonator 20 according to the present embodiment. The resonator 20 has an outer wall 22 that surrounds an interior space. At least one drain hole 24 is provided in the bottom surface of the outer wall 22 to prevent accumulation of water or the like. The drain hole 24 may have any shape, but is preferably circular. The drain hole 24 is formed as a penetrating channel 26 penetrating the outer wall 22, and the length of the penetrating channel 26 is extended by providing a thick portion at least on the periphery. The thick portion may be formed integrally with the outer wall, or may be formed by a post-process of attaching a member surrounding the drain hole 24 to the resonator by an adhesive or the like. The extended penetrating channel 26 has the effect of suppressing the airflow noise generated when air is sucked into the resonator 20 through the drain hole 24.

The entrance of the penetrating channel 26 may not be chamfered as depicted in FIG. 2(a), or may be r-chamfered as depicted in FIG. 2(b). According to tests conducted by the present inventors, the effect of suppressing airflow noise was found to be equally exhibited, regardless of the shape of the penetrating channel 26.

Preferably, the length of the penetrating channel 26 is twice the thickness of the outer wall 22. However, depending on the frequency of the airflow sound, and the like, the length of the penetrating channel 26 may be set to be greater than or less than twice the thickness of the outer wall 22.

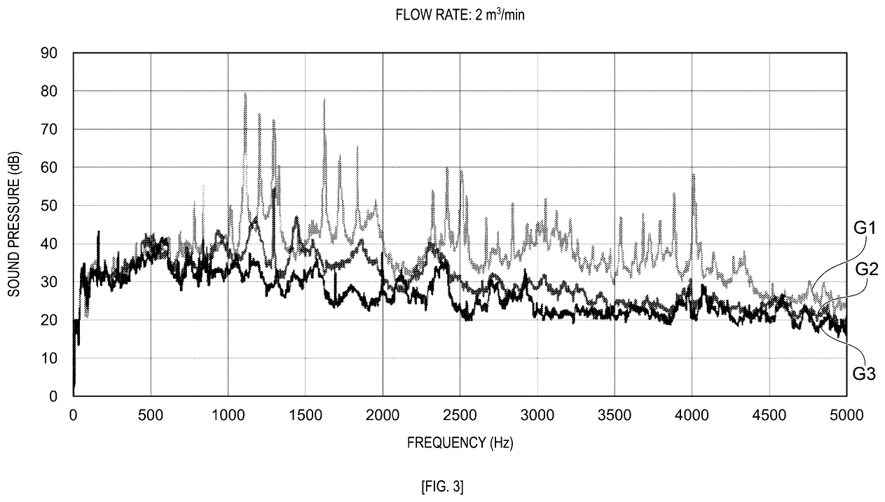

FIG. 3 is a graph depicting the effect of suppressing airflow noise by the resonator 20 according to the present embodiment. The graph shows the frequency spectrum of the airflow sound generated from one of the resonators 20 depicted in FIG. 2, with the horizontal axis showing the frequency (hz) and the vertical axis showing the sound pressure (db). Curve g1 in the graph corresponds to the airflow noise generated from a resonator with a normal water drain hole, curve g2 corresponds to the airflow noise generated from a resonator with a water drain hole that is an extension of the through hole according to the present embodiment, and curve g3 corresponds to the airflow noise generated from a resonator where the water drain hole is completely blocked. The sound pressure values of curve g2 are obviously suppressed relative to the sound pressure values of curve g1 in almost the entire frequency range shown in the figure. It can also be seen that the sound pressure value of curve g2 has many frequency ranges that are not significantly different from the sound pressure value of curve g3 when the drain hole is blocked. In this manner, airflow noise can be significantly suppressed by forming the drain hole 24 of the resonator 20 as an extended penetrating channel 26.

The extended penetrating holes in the resonator according to the present embodiment may be used in combination with known tuning holes, protrusions, or baffle shapes, and the like, also provided in the resonator.

In the present embodiment, the resonators 20, 20′ have one water drain hole 24 at each end of the resonator in the flow direction of the intake duct 10. Thereby, passage of air through the resonators 20, 20′ via the water drain hole 24 is inhibited by separating the water drain hole 24 from the neck of the resonator 20, 20′ (i.e., the flow path side of the intake duct) as far as possible, thereby minimizing the occurrence of resonant noise caused by the water drain hole 24. Note that the reason for providing only one hole is to suppress the reduction in the resonator effect caused by providing the hole.

In the present embodiment, the drain hole 24 of the resonator 20 is provided with a thick portion, but the drain hole 24 of the resonator 20′ is not provided with the thick portion. This is because actual measurements confirmed that the resonator 20′ is not affected by resonance noise caused by the drain holes 24.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. An air intake duct for a motor vehicle, comprising:
a resonator having an outer wall defining an internal space;
at least one drain hole configured as a penetrating channel through a bottom surface of the outer wall; and
a thick portion disposed at least around a periphery of the drain hole, the thick portion increasing a length of the penetrating channel.

2. The air intake duct according to claim 1, wherein the penetrating channel includes a port having a radius.

3. The air intake duct according to claim 1, wherein the length of the penetrating channel is approximately twice a thickness of the outer wall.

4. The air intake duct according to claim 1, further comprising a plurality of additional resonators arranged on a side of the air intake duct, and wherein each additional resonator that includes a water drain has a single water drain hole located at one end of the additional resonator.

5. The air intake duct according to claim 4, wherein an additional thick portion is provided only on the additional resonator in which the presence of the water drain hole causes a higher resonance sound.

6. The air intake duct according to claim 2, wherein the length of the penetrating channel is approximately twice a thickness of the outer wall.
